(19) United States
(12) Patent Application Publication
(10) Pub. No.: US 2026/0008211 A1
(43) Pub. Date: Jan. 8, 2026

(54) RESIN-MOLDED PRODUCT, PRODUCTION METHOD THEREFOR, AND LIQUID DISCHARGE HEAD USING RESIN-MOLDED PRODUCT

(71) Applicant: CANON KABUSHIKI KAISHA, Tokyo (JP)

(72) Inventors: DAIKI YAMAMOTO, Kanagawa (JP); YUKUO YAMAGUCHI, Tokyo (JP); RYO SATO, Kanagawa (JP); SHIMPEI YOSHIKAWA, Kanagawa (JP)

(21) Appl. No.: 19/254,974

(22) Filed: Jun. 30, 2025

(30) Foreign Application Priority Data
Jul. 8, 2024 (JP) 2024-109886

(51) Int. Cl. B29C 45/00; B29C 45/16; B29L 31/00; B41J 2/175

(52) U.S. Cl. CPC B29C 45/0025; B29C 45/16; B41J 2/175; B29C 2045/0039; B29L 2031/7678

(57) ABSTRACT

A production method for a resin-molded product includes preparing a mold frame including an accommodation portion accommodating the first resin member therein, a first flow path extending in a first direction, and a second flow path extending in a second direction intersecting the first direction and making the first flow path and the first resin member in the accommodation portion communicate with each other, injecting a molten resin forming the second resin member into the first flow path and causing the molten resin to flow from the first flow path to the second flow path, contacting the molten resin and the first resin member to form a welded portion between the molten resin and the first resin member, and cooling the molten resin to form the second resin member, wherein the welded portion is formed in the second flow path.

### BACKGROUND

### Field of the Technology

The present disclosure relates to a resin-molded product, a production method for the resin-molded product, and a liquid discharge head using the resin-molded product.

### Description of the Related Art

There is known a resin-molded product that is produced by joining a first resin member (primary molded product) containing a first resin, and a second resin member (secondary molded product) containing a second resin. Such a resin-molded product is produced by preparing the first resin member in a mold frame, injecting the molten second resin into the same mold frame, and then cooling the molten second resin so that it becomes hard after the molten second resin and the first resin member are brought into contact with each other. Such a production method is referred to as a two-color molding. In the two-color molding, a resin-molded product with a complex shape can be produced, and component assembling processes can be reduced. However, in such a production method, when the first resin member accommodated in the mold frame shrinks, a gap is formed between the mold frame and the first resin member, and there is a possibility that the molten second resin intrudes into the gap and causes a defect of the resin-molded product.

Japanese Patent Application Laid-Open No. 2022-112467 discusses a resin-molded product that is produced by a production method in which the shape of the first resin member is devised to prevent such a defect, so that no gap is formed between the first resin member and the mold frame.

However, while the method discussed in Japanese Patent Application Laid-Open No. 2022-112467 can suppress generation of the gap between the first resin member and the mold frame, there is a possibility that the first resin member melts again when the molten second resin comes in contact with the first resin member and a molding defect occurs. For example, when the second resin in a melted state injected into the mold frame remelts and entraps the first resin member, since the first resin member penetrates deeply into the second resin and causes a molding defect, there is a concern that a function desired for the first resin member may be hindered.

### SUMMARY

In view of the above-described issue, the present disclosure is directed to a resin-molded product in which a molding defect of a first resin member due to a molten second resin is suppressed, a production method for the resin-molded product, and a liquid discharge head using the resin-molded product.

According to an aspect of the present disclosure, a production method for a resin-molded product formed by welding a first resin member and a second resin member includes preparing a mold frame including an accommodation portion accommodating the first resin member therein, a first flow path extending in a first direction, and a second flow path extending in a second direction intersecting the first direction and making the first flow path and the first resin member in the accommodation portion communicate with each other, injecting a molten resin forming the second resin member into the first flow path and causing the molten resin to flow from the first flow path to the second flow path, contacting the molten resin and the first resin member to form a welded portion between the molten resin and the first resin member, and cooling the molten resin to form the second resin member, wherein the welded portion is formed in the second flow path.

Features of the present disclosure will become apparent from the following description of embodiments with reference to the attached drawings. The following description of embodiments are described by way of example.

### BRIEF DESCRIPTION OF THE DRAWINGS

FIG. 1 is an enlarged cross-section diagram illustrating a resin-molded product according to a conventional embodiment.

FIG. 2 is an enlarged cross-section diagram illustrating an injection process of a second resin according to the conventional embodiment.

FIG. 3 is an enlarged cross-section diagram illustrating the injection process of the second resin according to the conventional embodiment.

FIG. 4 is an enlarged cross-section diagram illustrating a vicinity of welded portions of a resin-molded product.

FIG. 5 is an enlarged cross-section diagram illustrating an injection process of a second resin.

FIG. 6 is an enlarged cross-section diagram illustrating the injection process of the second resin after a certain period of time has elapsed from the state illustrated in FIG. 5.

FIG. 7 is an enlarged cross-section diagram illustrating a resin-molded product according to a modification.

FIG. 8 is an enlarged cross-section diagram illustrating a resin-molded product according to a modification.

FIG. 9 is an enlarged cross-section diagram illustrating a resin-molded product according to a modification.

FIG. 10 is an enlarged cross-section diagram illustrating a resin-molded product according to a modification.

FIG. 11 is an enlarged cross-section diagram illustrating a resin-molded product according to a modification.

FIG. 12 is an exploded perspective diagram illustrating a liquid discharge head.

FIGS. 13A and 13B are an exploded diagram and a cross-section diagram, respectively, illustrating a liquid discharge head according to a conventional embodiment.

FIGS. 14A and 14B are an exploded diagram and a cross-section diagram, respectively, illustrating a liquid discharge head using the resin-molded product according to the present exemplary embodiment.

### DESCRIPTION OF THE EMBODIMENTS

Hereinafter, a conventional embodiment and an exemplary embodiment of the present disclosure will be described with reference to the drawings. The following exemplary embodiment does not limit the present disclosure, and not all combinations of features described in the exemplary embodiments are necessarily essential to the solution of the present disclosure. The same reference numerals are given to the same components. Description of Conventional Embodiment.

First, with reference to the attached drawings, an issue of a production method for a resin-molded product 100 according to a conventional embodiment will be described.

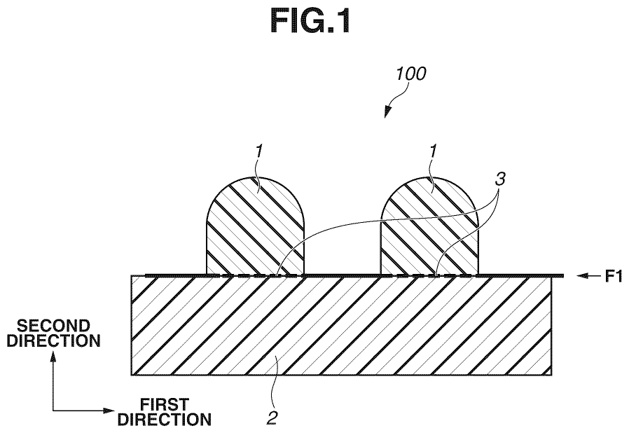

FIG. 1 is an enlarged cross-section diagram illustrating welded portions 3 of the resin-molded product 100 according to the conventional embodiment. First resin members 1 each containing a first resin and a second resin member 2 containing a second resin are welded at the respective welded portions 3 to form the resin-molded product 100. The first resin members 1 are a primary molded product in a two-color molding, and the second resin member 2 is a secondary molded product in the two-color molding. More specifically, the molten first resin is cooled to form the first resin members 1, and then the molten second resin is cooled in a mold frame in a state of contacting the first resin members 1 to form the second resin member 2. In this way, the resin-molded product 100 is produced. The resin-molded product 100 is formed so that the first resin members 1 and the second resin member 2 have respective functions. For example, the first resin members 1 are molded to have a function of a joint seal member for joining another member and the second resin member 2.

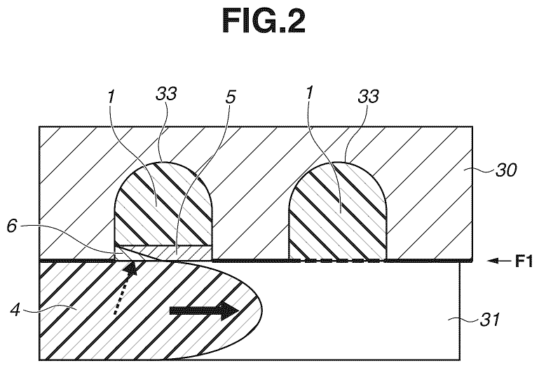

FIG. 2 is an enlarged cross-section diagram illustrating an injection process of the second resin according to the conventional embodiment. The resin-molded product 100 is produced by welding the first resin members 1 and the second resin member 2 in a mold frame 30. The mold frame 30 has a first flow path 31 extending in a first direction. The mold frame 30 is provided with accommodation portions 33, and the first resin members 1 formed in a previous process is accommodated in the accommodation portions 33 so as to face the first flow path 31. A molten resin 4 that forms the second resin member 2 is injected into the first flow path 31. The molten resin 4 flows through the first flow path 31 in a thick arrow direction illustrated in FIG. 2. At this time, since the first resin members 1 are accommodated in the accommodation portions 33 so as to face the first flow path 31, the molten resin 4 contacts the first resin members 1. Since the molten resin 4 is in a high-temperature state, when the molten resin 4 contacts one of the first resin members 1 located on the left side in FIG. 2 (hereinbelow, sometimes refers to the left-side first resin member 1), heat from the molten resin 4 is transferred to the left-side first resin member 1 to remelt the surface of the left-side first resin member 1, and a melted portion 5 is formed. Since the melted portion 5 is softened, the molten resin 4 flowing in the first flow path 31 may intrude into the left-side first resin member 1, and there is a possibility that an intruded portion 6 is formed. When the molten resin 4 is cooled, the second resin member 2 is formed, and the first resin members 1 and the second resin member 2 are welded together. However, when the first resin members 1 and the second resin member 2 are welded in a state where intruded portions 6 are formed, a molding defect of the resin-molded product 100 occurs. As described above, in the case where the first resin members 1 have the function of the joint seal member, if the molding defect of the resin-molded product 100 occurs, because elastic forces of the first resin members 1 change, there is a possibility that the desired function is not satisfied.

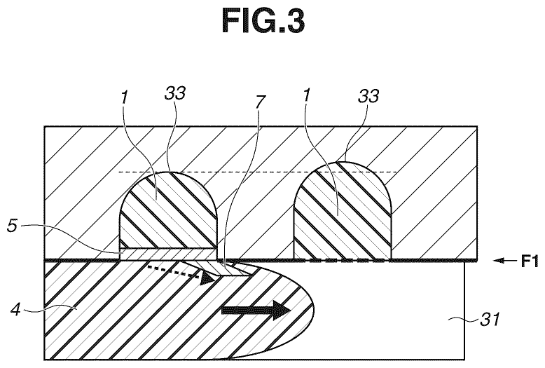

Further, as illustrated in FIG. 3, when the molten resin 4 flows through the first flow path 31, the first resin members 1 may be caught therein, and there is a possibility that a protrusion portion 7 is formed in the first flow path 31. In this case, because a dimensional deviation occurs in the first resin member 1 that causes the molding defect of the resin-molded product 100, there is a possibility that the first resin members 1 and the second resin member 2 do not achieve the desired functions.

Next, a resin-molded product 100 and a production method for the resin-molded product 100 according to the present disclosure will be described.

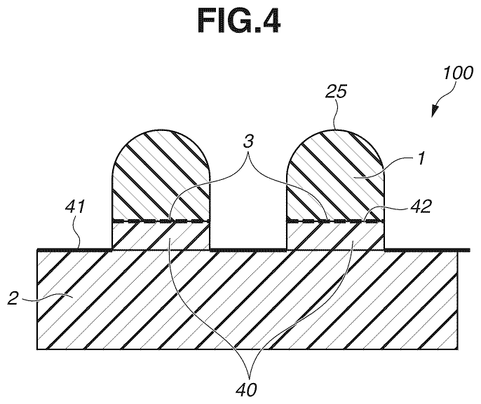

FIG. 4 is an enlarged diagram illustrating a vicinity of welded portions 3 of the resin-molded product 100 according to a first exemplary embodiment. First, contents similar to those of the conventional embodiment will be described. Similar to the conventional embodiment, first resin members 1 each containing a first resin and a second resin member 2 containing a second resin are welded at the respective welded portions 3 to form the resin-molded product 100 according to the present exemplary embodiment. The first resin members 1 are a primary molded product in the two-color molding, and the second resin member 2 is a secondary molded product in the two-color molding. More specifically, the molten first resin is cooled to form the first resin members 1, and then the molten second resin is cooled in a mold fame in a state of contacting the first resin members 1 to form the second resin member 2. In this way, the resin-molded product 100 is produced. The mold frame 30 is preferably a mold made of a metal.

The resin-molded product 100 is formed so that the first resin members 1 and the second resin member 2 have respective functions. For example, the first resin members 1 are molded to have a function of the joint seal member for joining another member and the second resin member 2. The resin-molded product 100 according to the present exemplary embodiment is suitable for a liquid discharge head. Details thereof will be described below.

A difference between the resin-molded product 100 according to the present exemplary embodiment and that according to the conventional embodiment will be described. The resin-molded product 100 according to the present exemplary embodiment is different from that according to the conventional embodiment in that the second resin member 2 has a first surface 41, protrusions 40 protruding from the first surface 41, and second surfaces 42, which are edge faces of the respective protrusions 40, and the second surfaces 42 are welded to the first resin members 1.

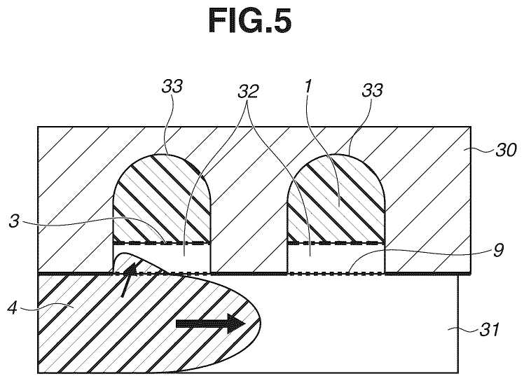

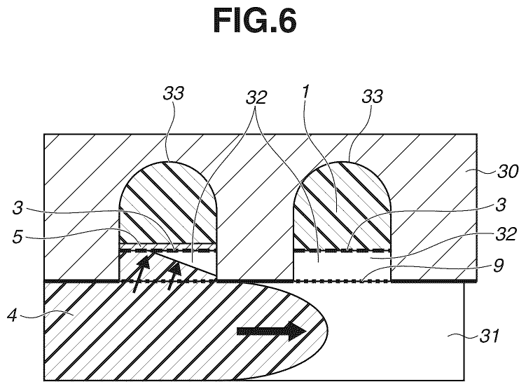

FIG. 5 is an enlarged cross-section diagram illustrating an injection process of the second resin. FIG. 6 is an enlarged cross-section diagram illustrating the injection process of the second resin after a certain period of time has elapsed from the state illustrated in FIG. 5. Similar to the conventional embodiment, the resin-molded product 100 is produced by welding the first resin members 1 and the second resin member 2 in the mold frame 30. The mold frame 30 accommodates the first resin members 1, and includes a second flow path 32 extending in a second direction intersecting the first direction and making the first flow path 31 and the first resin members 1 communicate with each other, in addition to the first flow path 31 extending in the first direction. For the production method for the resin-molded product 100 according to the present exemplary embodiment, it is sufficient to prepare the mold frame that accommodates the first resin members 1 and has the first flow path 31 and the second flow path 32. The molten resin 4 forming the second resin member 2 is injected into the first flow path 31. At this time, the molten resin 4 flows through the first flow path 31 in a thick arrow direction illustrated in FIG. 5.

Next, the reason why the molding defect is suppressed by the resin-molded product 100 and the production method for the resin-molded product 100 according to the present exemplary embodiment will be described. Compared with the conventional embodiment, in the production method for the resin-molded product according to the present exemplary embodiment, since the mold frame 30 has the second flow path 32, the first resin members 1 do not face the first flow path 31. Generally, because the injected molten resin 4 has a characteristic of flowing into an area where space is more widely available, in the present exemplary embodiment, the speed of the molten resin 4 flowing from the first flow path 31 to the second flow path 32 is slower than that flowing through the first flow path 31. For this reason, even when the left-side first resin member 1 contacting the molten resin 4 remelts and the melted portion 5 is formed, pressure acting on the melted portion 5 in the first direction becomes small. As a result, the possibility that the first resin members 1 are caught in the flow of the molten resin 4 and the possibility that the molten resin 4 intrudes into the first resin members 1 are suppressed. Accordingly, the molding defect of the first resin members 1 due to the molten second resin can be suppressed. In this case, the welded portions 3 are formed within the second flow path 32 without protruding into the first flow path 31. When the molten resin 4 is cooled in this state, the second resin member 2 is formed, and the resin-molded product 100 is produced by the first resin members 1 and the second resin member 2 being welded together.

The molten resin 4 less easily flows from the first flow path 31 as the cross-section area of the second flow path 32 is smaller. Thus, making the cross-section area of the second flow path 32 smaller and the length of the second flow path 32 longer is considered. However, the welded portions 3 need to be formed to weld the first resin members 1 and the molten resin 4 (second resin member 2). In order to form the welded portions 3 and firmly assemble the first resin members 1 and the second resin member 2, it is necessary to set various conditions to favorable forms. In particular, in order to provide the first resin members 1 with a function of the joint seal member as described above, it is necessary that the first resin members 1 and the second resin member 2 are firmly welded and the function of the first resin members 1 is not hindered. Hereinbelow, the favorable forms will be described.

It is desirable that the welded portions 3 are compatible parts between the first resin members 1 and the molten resin 4 (second resin member 2) to firmly join the first resin members 1 and the molten resin 4 (second resin member 2). The compatible parts are formed by melting the first resin members 1 in addition to melting the resin 4, and thus the first resin members 1 and the second resin member 2 can be joined firmly.

It is desirable that the first resin members 1 contain the first resin as a main material, the second resin member 2 contains the second resin as a main material, and the first resin and the second resin are different from each other. By making the first resin and the second resin different, it is possible to provide the first resin members 1 and the second resin member 2 with respective desired functions.

Further, the molten second resin injected into the first flow path 31 needs to contact the first resin members 1 without being cooled and fixed in the second flow path 32. Thus, a melting temperature of the second resin is desirably higher than that of the first resin.

In addition, the first resin may desirably be thermoplastic elastomer. In this way, it is possible to provide a liquid contact property and a close contact property similar to those of a rubber component to the first resin members 1 while reducing costs. On the other hand, the second resin may desirably be denatured polyphenylene ether. In general, the melting temperature of the denatured polyphenylene ether is higher than that of the thermoplastic elastomer, and thus the first resin members 1 and the second resin member 2 can be firmly assembled. Thus, it is desirable that the first resin is the thermoplastic elastomer, and the second resin is the denatured polyphenylene ether.

The welded portions 3 are desirably formed only in the second flow path 32. More specifically, it is desirable that the second resin member 2 is welded to the first resin members 1 only at the second surfaces 42.

In this way, it is possible to suppress the molding defect of the resin-molded product 100.

Further, an end 25 of the first resin members 1 on the opposite side of the second resin member 2 is desirably rounded. In this way, it is possible to increase adhesion strength with another component contacting the first resin members 1.

Next, modifications of the present exemplary embodiment will be described.

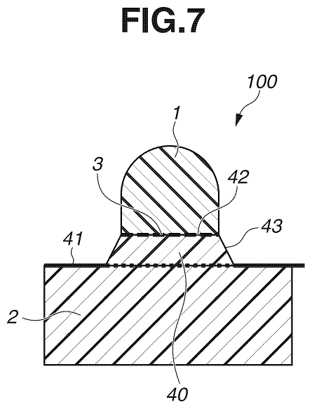

FIG. 7 is an enlarged cross-section diagram illustrating a resin-molded product 100 according to a modification. In a resin member illustrated in FIG. 7, a side surface 43 of a protrusion 40 connecting a first surface 41 and a second surface 42 inclines with respect to the first direction (first surface). With this inclination, since a range of selectable shape for the first resin members 1 and the second resin member 2 is broadened, the desired function can be easily provided to the resin-molded product 100. In addition, an inclination angle of the side surface 43 of the protrusion 40 is not specifically limited. In order to produce the resin-molded product 100 with the side surface 43 of the protrusion 40 inclined, it is desirable to use a mold frame 30 with a wall of the second flow path 32 inclined with respect to the first direction. In this way, the resin-molded product 100 with the side surface 43 of the protrusion 40 inclined can be easily produced.

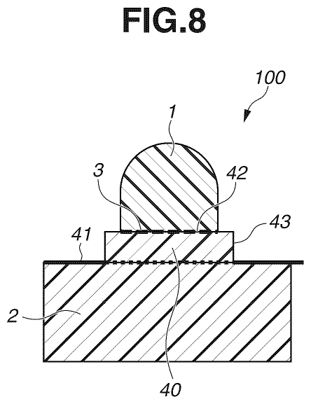

FIG. 8 is an enlarged cross-section diagram illustrating a resin-molded product 100 according to a modification different from that in FIG. 7. As illustrated in FIG. 8, a side surface 43 of a protrusion 40 is not aligned with a side surface of a first resin member 1. Even with such a configuration, it is possible to suppress the molding defect of the resin-molded product 100 as long as the second resin member 2 is welded with the first resin member 1 at the second surface 42 of the second resin member 2.

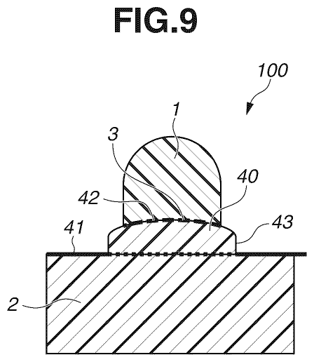

FIG. 9 is an enlarged cross-section diagram illustrating a resin-molded product 100 according to a modification different from those in FIGS. 7 and 8. In the modification illustrated in FIG. 9, a welded portion 3 formed on the second surface 42 of the protrusion 40 has a curved surface. Even with such a configuration in which the welded portion 3 has the curved surface, it is possible to suppress the molding defect of the resin-molded product 100 as long as the second resin member 2 is welded with the first resin member 1 at the second surface 42 of the second resin member 2.

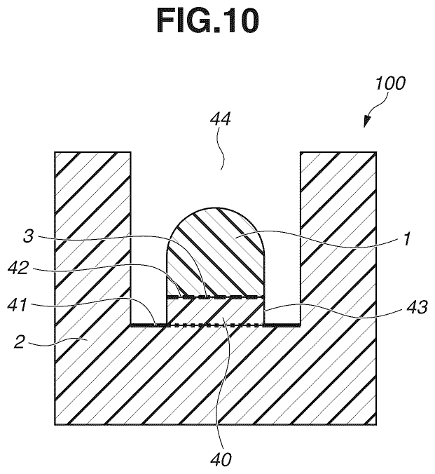

FIG. 10 is an enlarged cross-section diagram illustrating a resin-molded product 100 according to a modification different from those in FIGS. 7, 8, and 9. As illustrated in FIG. 10, a recessed portion 44 may be formed in a second resin member 2, and the first resin member 1 may be welded on the second surface 42 in the recessed portion 44. Even with such a configuration, it is possible to suppress the molding defect of the resin-molded product 100 as long as the first resin member 1 is welded to the second surface 42.

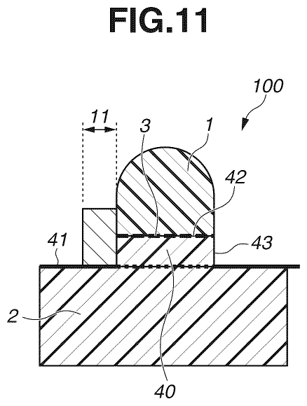

FIG. 11 is an enlarged cross-section diagram illustrating a resin-molded product 100 according to a modification different from those in FIGS. 7, 8, 9, and 10. The resin-molded product 100 illustrated in FIG. 11 includes a runner portion 11 where the molten first resin has flowed when the first resin member 1 is accommodated in the mold frame 30. More specifically, the runner portion 11 is formed by the first resin, which has flowed in a third flow path (not illustrated) in a mold frame in which the third flow path for filling the mold frame 30 with the molten first resin is formed, being solidified.

In other words, the runner portion 11 is a route where the first resin has flowed, and since a desired function is not provided thereto unlike the first resin member 1, when the runner portion 11 contacts the molten second resin, the runner portion 11 may intrude into the second flow path 32.

### <Application Example of Resin-Molded Product>

An application example of the resin-molded product 100 according to the present exemplary embodiment will be described. The resin-molded product 100 according to the present exemplary embodiment is suitable for a liquid discharge head 200 of an ink jet printer.

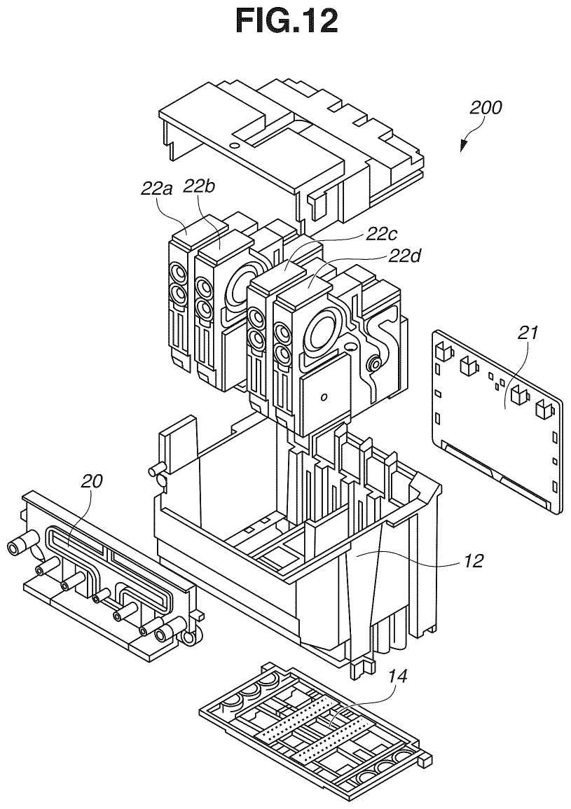

FIG. 12 is an exploded perspective diagram illustrating the liquid discharge head 200. The liquid discharge head 200 includes liquid discharge element substrates (not illustrated) for discharging liquid, a support member 14 for supporting the liquid discharge element substrates, reservoir members 22 (22a, 22b, 22c, and 22d) for reserving liquid to be supplied to the respective liquid discharge element substrates, and a housing 12 for housing the reservoir members 22.

Each of the liquid discharge element substrates (not illustrated) is provided with an energy-generation element to discharge liquid by pressure generated by the energy-generation element being applied to the liquid in each liquid discharge element substrate. The energy-generation element may be of a thermal method that generates the pressure for discharging liquid by a thermoelectric transducer, or may be of a piezoelectric method that generates the pressure for discharging liquid by a piezoelectric element. Further, other various liquid discharge methods may be used.

In a case where the liquid discharge head 200 discharges liquids of a plurality of colors, as illustrated in FIG. 12, the liquid discharge head 200 includes the plurality of reservoir members 22 (22a, 22b, 22c, and 22d). Each of the reservoir members 22 may desirably include a pressure adjustment unit (not illustrated) for adjusting the pressure of the liquid discharged from the liquid discharge element substrate, and a circulation pump (not illustrated) for circulating the liquid in a flow path of the liquid discharge head 200.

Further, the liquid discharge head 200 includes an electric wiring substrate 21 for supplying electric power to the liquid discharge element substrates, and a joint member 20 for connecting the main body of the ink jet printer and the reservoir members 22.

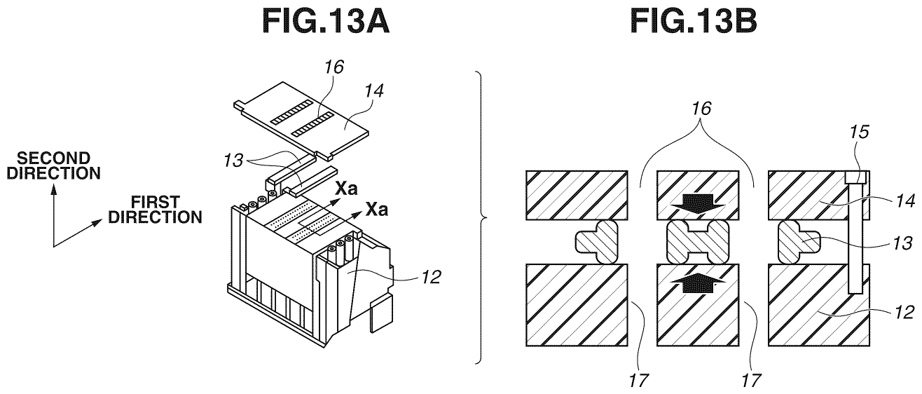

FIG. 13A is an exploded diagram of a liquid discharge head 200 according to the conventional embodiment in which the resin-molded product 100 according to the present exemplary embodiment is not used, and FIG. 13B is a cross-section diagram of the liquid discharge head 200 taken along cross-section line Xa-Xa illustrated in FIG. 13A. The support member 14 and the housing 12 are assembled with a fixing member (screw) 15. The housing 12 has housing openings 17 arranged in line in the first direction for supplying liquid to the support member 14, and the support member 14 has a plurality of support member openings 16 through which liquid is supplied from the housing 12.

Joint seal members 13 are in pressure-contact with a peripheral portion of each of the housing openings 17 of the housing 12 and a peripheral portion of each of the support member openings 16 of the support member 14. In this manner, the liquid discharge head 200 is formed. With this configuration, the joint seal members 13 need to be pressed by both the peripheral portion of each of the housing openings 17 and the peripheral portion of each of the support member openings 16 to seal a gap therebetween, and thus, it is necessary to press them with a large force.

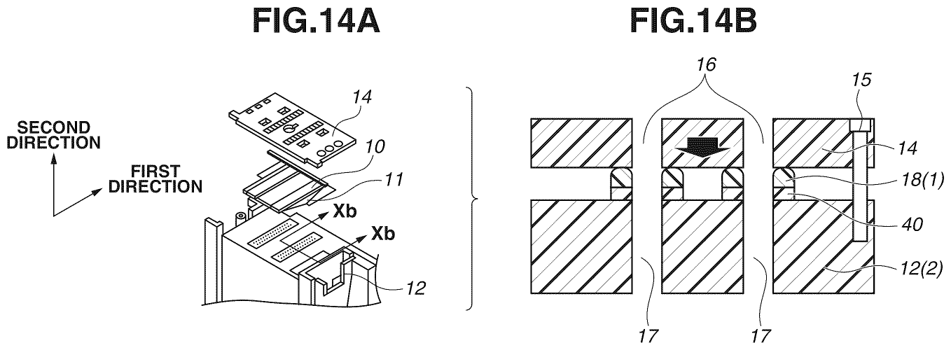

FIG. 14A is an exploded diagram of the liquid discharge head 200 using the resin-molded product 100 according to the present exemplary embodiment, and FIG. 14B is a cross-section diagram of the liquid discharge head 200 taken along cross-section line Xb-Xb illustrated in FIG. 14A. In the liquid discharge head 200 according to the present exemplary embodiment, similar to the conventional embodiment, the support member 14 and the housing 12 are assembled with the fixing member (screw) 15. The housing 12 has the housing openings 17 arranged in line in the first direction for supplying liquid to the support member 14, and the support member 14 has the plurality of support member openings 16 through which liquid is supplied from the housing 12. The liquid discharge head 200 illustrated in FIGS. 14A and 14B is different from the conventional embodiment in that the housing 12 and joint seal members 18 are integrally formed as the resin-molded product 100 according to the present exemplary embodiment. In other words, the housing 12 is the second resin member 2, the joint seal members 18 are the first resin members 1, and the first resin members 1 are pressure-pressed against peripheral portions of the plurality of support member openings 16. With this configuration, since the first resin members 1 and the second resin member 2 are integrally formed, a possibility of liquid leakage from the interface therebetween is reduced. Further, since the resin-molded product 100 only needs to secure sealing property between the first resin members 1 and the support member 14, the force pressing the housing 12 and the support member 14 can be reduced to about half of the force in the conventional embodiment.

While, in FIG. 14A, the housing 12 and the joint seal members 18 are illustrated in a separate manner, this is for the sake of description, and actually the housing 12 and the joint seal members 18 are integrally formed. In addition, the runner portion 11 may not be formed.

In a liquid discharge head that discharges ink, leakage of ink causes more serious damage than leakage of other liquids. Thus, the resin-molded product 100 according to the present exemplary embodiment is suitable for the housing (joint seal portions) of the liquid discharge head 200. In particular, it is desirable that the first resin members 1 are made of elastomer because adhesion to the support member 14 is improved and the liquid leakage can be suppressed.

In a case where the housing 12 and the joint seal members 18 of the liquid discharge head 200 are the resin-molded product 100 according to the present exemplary embodiment, because the shape of the resin-molded product 100 is matched with the shape of the support member 14, the resin-molded product 100 has a shape long in the first direction. When the resin-molded product 100 has the shape long in the first direction, the first flow path 31 in a production process of the resin-molded product 100 is also long in the first direction. When the first flow path 31 is long in the first direction, as the molten second resin flows from the front side to the back side on the first flow path 31 when the molten second resin flows through the first flow path 31, there is a possibility that the second resin is cooled and becomes hard.

When the second resin is cooled and becomes hard, since the welded portion with the first resin members 1 cannot be formed and the resin-molded product 100 cannot be produced, it is required to fill the first flow path 31 with the molten second resin in a high temperature state. With the production method for the resin-molded product 100 according to the present exemplary embodiment, since the molding defect of the first resin members 1 can be suppressed even when the temperature of the molten second resin is made higher, the resin-molded product 100 and the production method for the resin-molded product 100 according to the present exemplary embodiment is suitable for the liquid discharge head 200.

According to the present disclosure, it is possible to provide the resin-molded product in which the molding defect of the first resin member due to the molten second resin is suppressed, the production method for the resin-molded product, and the liquid discharge head using the resin-molded product.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-109886, filed Jul. 8, 2024, which is hereby incorporated by reference herein in its entirety.

What is claimed is:

1. A production method for a resin-molded product formed by welding a first resin member and a second resin member, the production method comprising:
preparing a mold frame including an accommodation portion accommodating the first resin member therein, a first flow path extending in a first direction, and a second flow path extending in a second direction intersecting the first direction and making the first flow path and the first resin member in the accommodation portion communicate with each other;
injecting a molten resin forming the second resin member into the first flow path and causing the molten resin to flow from the first flow path to the second flow path;
contacting the molten resin and the first resin member to form a welded portion between the molten resin and the first resin member; and
cooling the molten resin to form the second resin member,
wherein the welded portion is formed in the second flow path.

2. The production method for the resin-molded product according to claim 1, wherein the welded portion is formed by the molten resin and the first resin member being compatibilized.

3. The production method for the resin-molded product according to claim 1,
wherein the first resin member contains a first resin as a main material,
wherein the second resin member contains a second resin as a main material, and
wherein the first resin and the second resin are different from each other.

4. The production method for the resin-molded product according to claim 3, wherein a melting temperature of the second resin is higher than a melting temperature of the first resin.

5. The production method for the resin-molded product according to claim 3,
wherein the first resin is thermoplastic elastomer, and
wherein the second resin is denatured polyphenylene ether.

6. The production method for the resin-molded product according to claim 1,
wherein a wall surface of the second flow path inclines with respect to the first direction.

7. The production method for the resin-molded product according to claim 1,
wherein the welded portion is formed only in the second flow path.

8. The production method for the resin-molded product according to claim 1,
wherein the mold frame is provided with a third flow path through which a molten resin is supplied to form the first resin member, and
wherein in the preparing of the mold frame, the molten resin forming the first resin member is supplied to the mold frame through the third flow path, not through the first flow path, and the molten resin forming the first resin member is cooled to form the first resin member.

9. A resin-molded product comprising:
a first resin member; and
a second resin member welded together with the first resin member,
wherein the second resin member is provided with a first surface, a protrusion protruding from the first surface, and a second surface which is an end surface of the protrusion, and
wherein the second surface is welded with the first resin member.

10. The resin-molded product according to claim 9,
wherein the first resin member contains a first resin as a main material,
wherein the second resin member contains a second resin as a main material, and
wherein the first resin and the second resin are different from each other.

11. The resin-molded product according to claim 10, wherein a melting temperature of the second resin is higher than a melting temperature of the first resin.

12. The resin-molded product according to claim 10,
wherein the first resin is thermoplastic elastomer, and
wherein the second resin is denatured polyphenylene ether.

13. The resin-molded product according to claim 9, wherein an end of the first resin member opposite to the second resin member is rounded.

14. The resin-molded product according to claim 9, wherein a side surface of the protrusion that connects the first surface and the second surface inclines with respect to the first surface.

15. The resin-molded product according to claim 9, wherein the second resin member is welded with the first resin member only at the second surface.

16. A liquid discharge head comprising:
a discharge element substrate configured to discharge liquid;
a support member configured to support the discharge element substrate;
a reservoir member configured to store the liquid to be supplied to the discharge element substrate; and
a housing configured to house the reservoir member therein,
wherein the housing is a resin-molded product including:
a first resin member; and
a second resin member welded together with the first resin member,
wherein the second resin member is provided with a first surface, a protrusion protruding from the first surface, and a second surface which is an end surface of the protrusion, and
wherein the second surface is welded with the first resin member, and
wherein the support member and the first resin member are in pressure contact with each other.

17. The liquid discharge head according to claim 16, wherein the support member and the resin-molded product are assembled with a screw.

18. The liquid discharge head according to claim 16,
wherein the support member has a plurality of openings through which the liquid is supplied from the housing, and
wherein the first resin member is in pressure contact with a peripheral portion of each of the plurality of openings.
